(19) United States
(12) Patent Application Publication
(10) Pub. No.: US 2011/0227734 A1
(43) Pub. Date: Sep. 22, 2011

(54) PHARMACEUTICAL PRODUCT CONTAINER WITH MOTION SENSOR AND ALARM

(75) Inventors: Vernon D. Ortenzi, Burlington, KY (US); Robert J. Ziemba, Cincinnati, OH (US); Simon Alexander Karger, Somerville, MA (US); Brandon Craft, Reisterstown, MD (US); Jennifer Gell, Cambridge (GB)

(73) Assignee: MALLINCKRODT INC., Hazelwood, MO (US)

(21) Appl. No.: 13/015,498

(22) Filed: Jan. 27, 2011

Related U.S. Application Data
(60) Provisional application No. 61/300,202, filed on Feb. 1, 2010.

(51) Int. Cl. G08B 21/00

(52) U.S. Cl. 340/568.1

(57) ABSTRACT

Systems and methods for monitoring a container (180) for storing a pharmaceutical product (190) are presented. The container (180) may be monitored (210) such that container movement may be detected (212) and logic may be provided for determining if the movement was authorized. In the event of unauthorized movement, an alarm (140) may be activated (214) to alert a user or stakeholder of the unauthorized movement. The movement of the pharmaceutical product container (180) may be detected by way of a motion sensor (120) such as an accelerometer. The alarm (140) may comprise an auditory or visual alarm as well as a network communication indicative of the activation of an alarm. The alarm (140) may be prevented or canceled (218).

### CROSS-REFERENCE TO RELATED APPLICATIONS

This patent application claims priority to co-pending U.S. Provisional Patent Application Ser. No. 61/300,202, entitled “PHARMACEUTICAL PRODUCT CONTAINER WITH MOTION SENSOR AND ALARM,” filed on Feb. 1, 2010, and the entire disclosure of which is incorporated by reference in its entirety herein.

### FIELD OF THE INVENTION

The present invention generally relates to the field of pharmaceutical product containers and, more particularly, to monitoring access to a pharmaceutical product contained therein.

### BACKGROUND

Pharmaceutical products (which may also be referred to herein as medications and pharmaceuticals) may be subject to unauthorized access perpetrated by a patient, a patient's family, unscrupulous individuals, or others. The unauthorized access to medications may, in some instances, be in the form of the patient exceeding the prescribed dosage. For instance, the patient may take medication that has been prescribed to them more frequently than what was prescribed. Additionally, unscrupulous individuals may steal or otherwise gain unauthorized access to another's medication. This may be in an attempt to gain access to medication without a prescription for personal use and/or to sell the medication to others. The risk of these scenarios occurring may be heightened when such medications include U.S. Drug Enforcement Administration (DEA) scheduled (e.g., Schedule II) substances due to the susceptibility of these medications being abused.

Children or others may unwittingly, unknowingly, or accidentally gain access to medications. In some instances, a family member of a user may accidently gain access to a user's medications, thinking that the medications are their own. Such instances may result in allergic reactions, other side effects, or even death. Thus, unauthorized access to medications, whether it is intentional or accidental, may have serious consequences for the unauthorized user.

### SUMMARY

The present invention generally relates to detecting unauthorized movement of a pharmaceutical container, and activating at least one alarm in response to detection of at least a certain movement of such a container that is outside a dosage time period.

A first aspect of the present invention includes a pharmaceutical product supply that includes a container, a motion sensor that is associated with this container, pharmaceutical product within the container, and an alarm that is operatively interconnected with the motion sensor. The pharmaceutical product supply also includes control logic that is operatively interconnected to both the motion sensor and the alarm. The control logic is operable to define periods during which movement of the pharmaceutical product supply does not initiate an alarm. The control logic defines a dosage time period such that movement of the container detected during the dosage time period fails to initiate the alarm. Movement of the container detected outside the dosage time period, however, initiates the alarm.

Various refinements exist of the features noted in relation to the first aspect of the present invention. These refinements and additional features may exist individually or in any combination. For instance, various features discussed below in relation to any of the exemplary embodiments of the present invention may be incorporated into the first aspect of the present invention, alone or in any combination. The following discussion is applicable to the first aspect, up to the start of the discussion of a second aspect of the present invention.

In various embodiments, the motion sensor may be an accelerometer, a MEMS accelerometer, a mercury switch, a passive infrared sensor, another appropriate device, or any combination thereof. In one embodiment, the motion sensor may be incorporated by a base or base unit that has a receptacle to accommodate the container, although the container may be “docked” to the base in any appropriate manner. Motion may be detected if and when the container is removed from the base. Accordingly, the base may be fitted with any appropriate sensor or combination of sensors (e.g., a mechanical sensor, optical sensor, or other appropriate sensor) to determine if/when the container has been removed from the base. Another option is for the container to incorporate the motion sensor.

In various embodiments, the alarm may be an auditory alarm, a visual alarm, a wireless communication, an e-mail, a voicemail, a text message, an MMS message, an instant message, a telephone call, another appropriate alarm, or any combination thereof. Also, the alarm may be programmable. For instance, the programmable alarm may include a device that can record a customized message that is played or communicated when the alarm is initiated. For instance, the customized message may be a custom-recorded voice or audio message, or the customized message may be a predefined message that is communicated (e.g., by way of an e-mail, text message, or other communication). The container may include the alarm such that the alarm may be provided integrally with a portion of the container (e.g., the container body or a lid/cover may incorporate the alarm).

In an embodiment, the pharmaceutical product supply may include an alarm control module that may control the alarm. By “control,” it is meant that the alarm control module may initiate an alarm (e.g., upon receiving an appropriate signal from at least one sensor), prevent the alarm from initiating, cancel the alarm once initiated, and/or control the alarm in some other appropriate manner both before and after the alarm has been activated. For example, the alarm control module may be operable to disable the alarm prior to the alarm being activated. Additionally or alternatively, the alarm control module may be operable to cancel the alarm after the alarm has been activated. Any of the foregoing modes of control may be subject to the condition that the alarm is only activated when movement is detected outside the dosage time period.

In one embodiment, the alarm control module may include a timer. Upon expiration of the timer, the alarm may be cancelled. In one embodiment, the alarm control module may include an input, such as an input device or the like. For instance, in one embodiment, the input may be a binary input (e.g., an on/off switch) for communicating an on/off command. The on/off switch may be operative to disable the alarm prior to the alarm being activated or may allow for the alarm to be cancelled once activated. The on/off switch may be used to prevent unwanted or “annoyance” alarms (e.g., in situations where movement is expected and an alarm is not desired to be initiated even when movement is detected outside a dosage time period, for instance while taking the pharmaceutical product supply on a trip). The input may be operable to receive a control command including a personal identification number (PIN) or similar code. The input may include a numeric key pad (e.g., a ten-key numeric key pad) or any other appropriate input device or combination of input devices.

The alarm control module may be a wireless module. The wireless module may provide the same functionality as an alarm control module provided with the pharmaceutical product supply (e.g., the ability to receive a control command including a PIN or other code, receive an on/off command, etc.). The wireless module may also provide additional functionality. For instance, the wireless module may be operable to receive a control command in the form of a communication. The communication may be in the form a wireless communication, an e-mail, a voicemail, a text message, an MMS message, an instant message, a telephone call, other forms of electronic communication, or any combination thereof. The communication may include a PIN or other code to identify an authorized individual.

One embodiment of the pharmaceutical product supply may include a wireless key. The wireless key may be used such that when the wireless key is brought in proximity to the wireless module, the alarm may be controlled. The wireless key may be a magnetic element, an RFID tag, a capacitive element, other appropriate elements or any combination thereof. The alarm may not initiate when motion is detected if the wireless key is in proximity with the pharmaceutical product supply. Alternatively or additionally, an initiated alarm may be silenced or cancelled upon introduction of the wireless key in proximity to the pharmaceutical product supply.

As noted, the pharmaceutical product supply may include control logic that is operatively interconnected with each of the motion sensor and the alarm. For instance, the control logic may be operable to define periods during which movement of the pharmaceutical product supply does not initiate an alarm. For instance, the control logic may include or define a dosage time period. Movement of the container during the dosage time period may not result in, the initiation of the alarm. However, movement of the container outside the dosage time period may result in initiation of the alarm. In one embodiment, the control logic may include a programmable quiet time (e.g., outside a dosage time period) during which the alarm is inactive. The control logic may include a clock. The control logic in other embodiments may include other parameters or definitions to determine if the movement of the pharmaceutical product container should initiate an alarm in addition to the conditional functionality related to the dosing time period.

The pharmaceutical product supply may include a remote alarm operable in response to the alarm. The remote alarm may be provided in a location away from the container. For instance, the remote alarm may be provided such that a physician or other appropriate medical care provider or stakeholder may be alerted to movement of the container. The remote alarm may be in communication with the container (e.g., by way of a wireless technology or the like).

Further still, while the first aspect is presented with pharmaceutical product being present in the container, it is to be understood that a pharmaceutical product supply may be provided without the pharmaceutical product. That is, in one embodiment, a container including a motion sensor and an alarm operatively connected to the motion sensor may be provided without a pharmaceutical product being stored in the container.

A second aspect includes a method for alerting in response to movement of a pharmaceutical product container. The method includes tracking a dosage time period. The method also involves monitoring a position of the pharmaceutical product container. The pharmaceutical product container includes a pharmaceutical product stored in the container. The method further involves detecting movement of the pharmaceutical product container from the monitoring step and activating an alarm in response to the detecting step when the detecting step occurs outside of the dosage time period.

Various refinements exist of the features noted in relation to the second aspect of the present invention. These refinements and additional features may exist individually or in any combination. For instance, various features discussed below in relation to any of the exemplary embodiments of the present invention may be incorporated into the second aspect of the present invention, alone or in any combination.

In various embodiments, the monitoring step may include the use of a device such as an accelerometer, a MEMS accelerometer, a mercury switch, a passive infrared sensor, another appropriate device, or any combination thereof. Alternatively, the detecting step may include detecting removal of the pharmaceutical product container from a base or a base unit using any appropriate sensor or combination of sensors. The container may be “docked” to the base in any appropriate manner, such as by being disposed within an appropriately-sized receptacle.

The activating step may include activating an alarm, such as an auditory alarm, a visual alarm, a wireless communication, an e-mail, a voicemail, a text message, an MMS message, an instant message, a telephone call, another appropriate communication, or any combination thereof. The alarm may be provided such that the pharmaceutical product container includes the alarm. For instance, the alarm may be incorporated by the container body and/or container lid. The activating step may also include activating a remote alarm. The remote alarm may be provided away from the pharmaceutical product supply. The remote alarm may be communicated with wirelessly (e.g., using a wireless technology or a network communication). Both a local alarm and a remote alarm may be utilized.

In an embodiment, the method of the second aspect may include programming the alarm. The programming may include recording a customized message. For instance, the programming may include recording a voice message. Upon initiating the alarm, the recorded message may be played back. Alternatively, in the case of an alarm that includes a communication, a customized message may be provided that is, in turn, sent at the initiation of an alarm.

In another embodiment, the additional step of controlling the alarm may be performed (e.g., regardless of whether movement is detected during or outside a dosage time period). Alternatively, this may include embodiments where the alarm is not activated in response to movement even when movement is detected outside a dosage time period. For instance, at a first instance an alarm control command may be received and at a second instance an alarm control command may not be received. The detecting step in the second instance may result in execution of the activating step, and the detecting step in the first instance may not result in execution of the activating step. In an embodiment, the controlling step involves cancelling the alarm after the activating step. In another embodiment, the controlling step involves disabling the alarm prior to execution of the activating step.

In an embodiment, the controlling step may include receiving an input. The input may be in the form of an on/off command. Alternatively, the input may include a personal identification number or other appropriate code. Additionally or alternatively, the controlling step may involve receiving a control command via a wireless module. The wireless module may be operable to receive a control command in the form of a communication. For instance, the communication may be a wireless communication, an e-mail, a voicemail, a text message, an MMS message, an instant message, a telephone call, or any combination thereof.

In an embodiment, the controlling step involves introducing a wireless key in proximity to the wireless module. In turn, the wireless key may control the alarm. The wireless key may be a magnetic element, an RFID tag, a capacitive element, or any combination thereof. The controlling step may also involve controlling the alarm based on a timer.

A number of feature refinements and additional features are separately applicable to each of above-noted first and second aspects of the present invention. These feature refinements and additional features may be used individually or in any combination in relation to each of the above-noted first and second aspects.

A “pharmaceutical product” as used herein may generally define any material or substance used in the course of a medical treatment, medical diagnosis, therapy, or the provision of any other appropriate medical care. A given material need not contain an active drug compound or ingredient to be considered a “pharmaceutical product” for purposes of the present invention.

A pharmaceutical product within the container may be in any appropriate form, in any appropriate dose, and of any appropriate type. A pharmaceutical product encompasses both a single-dose configuration (e.g., a single pill) and a multiple dose configuration (e.g., a plurality of pills). Pharmaceutical product may be in any appropriate form such as (but not limited to) pills, tablets, chewables, capsules, powders, fluids (e.g., liquids, suspensions, emulsions), patches (e.g., transdermal patches), films (e.g., transmucosal or buccal), strips (e.g., transmucosal or buccal), or the like. Further, a “pharmaceutical product” may refer to or include any “drug” as defined in Title 21 of the United States Code, Section 321(g)(1).

All pharmaceutical product within the container may be of at least substantially common dose. Alternatively, some pharmaceutical product could be of one dose (e.g., a prescribed dose), while some pharmaceutical product could be of a different dose (e.g., in the form of a transdermal patch that has been used by a patient, such that at least part of its original dosage has already been transdermally administered to a patient). All pharmaceutical product within the container could be in a common first condition. For instance and in the case of transdermal patches, all transdermal patches within the container could be contained within individual primary packaging (e.g., within a sealed pouch, jacket, foil wrapping, or the like), or all transdermal patches within the container could be in an exposed state (e.g., where the individual transdermal patches have been removed from their associated primary packaging before being disposed within the container). Some pharmaceutical product within the container could be in a common first condition, such as contained within individual primary packaging (e.g., within a sealed pouch, jacket, foil wrapping, or the like), while some pharmaceutical product within the container could be in a common second condition (e.g., in an exposed state or where the individual transdermal patches have been removed from their associated primary packaging before being disposed within the container).

Any transdermal patches utilized with the present invention may include any appropriate pharmaceutical product. Examples of appropriate pharmaceutical products that may be included in such transdermal patches include (but are not limited to): U.S. Drug Enforcement. Administration (DEA) scheduled (e.g., Schedule II) drugs such as fentanyl, lidocaine, tetracaine, prilocaine, thebaine, buprenorphine, sufentanil, alfentanil, codeine, dihydrocodeine, hydrocodone, hydromorphone, levorphanol, methadone, morphine, nalbuphine, noscapine, opium, oxycodone, and propoxyphene; non-steroidal anti-inflammatory drugs (NSAIDs) such as ketoprofen, diclofenac, flurbiprofen, and ibuprofen; steroids such as testosterone and estradiol; psychoactive drugs such as buspirone; vitamins such as vitamin B12; vasodilators such as nitroglycerin; vaccines; antiemetics; capsaicin; and nicotine. Further, any transdermal patches utilized with the present invention can function to provide drug delivery in any appropriate manner. For instance, such transdermal patches may include those functioning via a passive delivery mechanism (e.g., pharmaceutical product located within the adhesive of the patch, within a reservoir of the patch, within a semisolid matrix (e.g., a gel)) or via an active delivery mechanism (e.g., iontophoresis, sonophoresis, electroporation, microneedles, abrasion, needle-less injection, suction, stretching, magnetophoresis, radio frequency, lasers, photomechanical waves, temperature (e.g., heat-activation)).

Any of the embodiments, arrangements, or the like discussed herein may be used (either alone or in combination with, other embodiments, arrangements, or the like) with any of the disclosed aspects. Any feature disclosed herein that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that a pharmaceutical product supply includes “the alarm” alone does not mean that the container includes only a single alarm). Moreover, any failure to use phrases such as “at least one” also does not limit the corresponding feature to the singular (e.g., indicating that a pharmaceutical product supply includes “an alarm” alone does not mean that the container includes only a single alarm). Use of the phrase “at least generally,” “at least partially,” or the like in relation to a particular feature encompasses the corresponding characteristic and insubstantial variations thereof. Finally, a reference of a feature in conjunction with the phrase “in one embodiment” does not limit the use of the feature to a single embodiment.

### BRIEF DESCRIPTION OF THE FIGURES

FIG. 1 is a schematic of an embodiment of a pharmaceutical product supply that utilizes a motion detector and alarm.

FIG. 2 is an embodiment of a protocol for detecting motion of a pharmaceutical product container.

FIG. 3 is a perspective view of an embodiment of a pharmaceutical product supply that utilizes a motion detector and alarm.

FIG. 4 is a perspective view of an embodiment of a pharmaceutical product supply system that utilizes a container and an associated motion detector, along with a remotely located command station.

FIG. 5 is a perspective view of an embodiment of a pharmaceutical product supply system that utilizes a motion detector, alarm, and base unit.

### DETAILED DESCRIPTION

Various embodiments of pharmaceutical product containers will be described in relation to the accompanying figures. A pharmaceutical product container with pharmaceutical product therein may be referred to as a “pharmaceutical product supply.” In any case, these pharmaceutical product containers are configured to store “pharmaceutical product” as described herein (e.g., in any appropriate form, in any appropriate dose, and of any appropriate type), and furthermore include one or more features to facilitate the management of the use of the pharmaceutical product. By way of initial summary, each of the following embodiments utilize one or more motion detectors or sensors, along with one or more alarms that are activated in response to at least a certain detected motion of a pharmaceutical product container. Unless otherwise noted herein to the contrary, a feature addressed in relation to any one of the following embodiments may be utilized by each of the following embodiments. For instance, discussion provided in relation to a motion detector or sensor utilized by one of the embodiments should apply to all other embodiments that use such a motion detector or sensor, unless noted to the contrary.

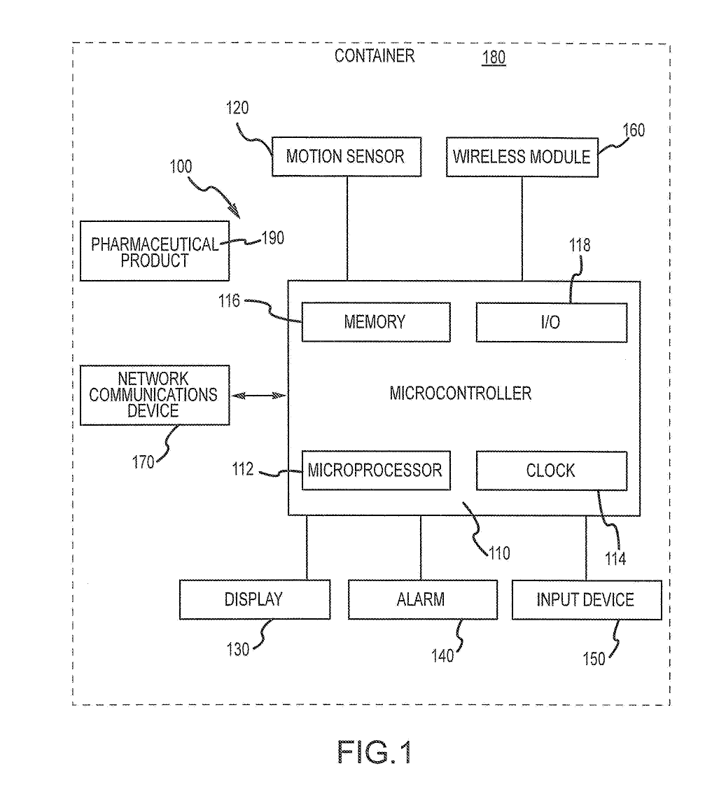

FIG. 1 depicts a schematic view of one embodiment of a pharmaceutical product supply 100 for detecting movement of a pharmaceutical product container 180 having a pharmaceutical product 190 therein and that is in accordance with the foregoing. The pharmaceutical product container 180 may be of any appropriate size, shape, configuration, and/or type (e.g., a container body with an externally disposed cover that is movable between open and closed positions, including being totally removable from the container body or being movably interconnected (e.g., pivotally) with the container body). Any one or more of the components that will be addressed in relation to the pharmaceutical product supply 100 may be incorporated by the container 180 in any appropriate manner, one or more of such components may not actually be incorporated by the structure of the container 180 itself, or any combination thereof.

The pharmaceutical product supply 100 may include a microcontroller 110. The microcontroller 110 may have several components or functions that may be integrated on a single chip or may comprise individual components in communication. The microcontroller 110 may include a microprocessor 112 that is operative to control the operation of the microcontroller 110.

The microcontroller 110 may further include a clock module 114. The clock module 114 may comprise hardware, software, firmware, or any combination thereof. In one embodiment, the clock module 114 may include, for example a piezoelectric crystal clock (e.g., a quartz clock). The clock module 114 may supply a timing signal to the microcontroller 110 that is utilized by the microprocessor 112 in order to define or track periods of time. For instance and in one embodiment, the clock module 114, in conjunction with the microprocessor 112, may be operative to define and track periods of time corresponding to a dosing regimen of the pharmaceutical product 190 stored in the container 180. The clock module 114 may also track periods of time during which access to the pharmaceutical product 190 is authorized or during which authorization must be received in an embodiment of the pharmaceutical product supply 100. The clock module 114 may also track periods of time during which an alarm 140 of the pharmaceutical product supply 100 is inactive (e.g., a quiet time).

A dosage regimen may be defined by a dosage interval and a dosage time period. A dosage interval may correspond to a period between doses or use of the pharmaceutical product 190. For instance, for a twice daily dose, a dosage interval may be twelve hours. Any dosage interval may be provided based on the pharmaceutical product 190 and/or physician's prescription. A dosage time period may correspond to the amount of time allowed at a dosage interval for the patient to use the pharmaceutical product 190 at the dosage interval. The dosage time period may begin at the conclusion of a dosage interval or the dosage time period may be provided surrounding a dosage interval. For example, a dosage time period may include a one-hour period (or any other appropriate time period) surrounding a dosage interval during which the pharmaceutical product 190 may be used or otherwise administered to a patient. The dosage period may begin one half-hour prior to the conclusion of the dosage interval and continue for one-half hour after the conclusion of the dosage interval. Accordingly, access to or movement of the container 180 outside of a dosage time period may result in initialization of an alarm 140 of the pharmaceutical product supply 100. In this regard, dosage time periods may define a discrete period during which access to the container 180 does not initialize the alarm 140. Dosage time periods may be repetitively provided at dosage intervals. Thus, a recurring access period may be established by way of a repetitive dosage time period. A dosage regimen may be predefined for a pharmaceutical product such that identification of the pharmaceutical product 190 may automatically generate a dosage regimen.

Additionally or alternatively, the clock module 114 may be operative to define periods during which authorization may occur. That is, the clock module 114 may define and track a period of time during which a user must indicate that the user is in fact authorized to move a container. In the case where no authorization indication is received during the period defined by the clock module 114, any detected movement may initialize the alarm 140. Conversely, if the authorization indication is received, the alarm 140 may not initialize.

The microcontroller 110 may further include a memory 116. The memory 116 may be random access memory, read only memory, or any other appropriate memory, including a combination of one or more memory types. The microcontroller 110 may also include an I/O module 118 that may be operative to direct communication to and from the microcontroller 110 to various other components of the pharmaceutical product supply 100 or other devices.

The pharmaceutical product supply 100 may further include at least one motion sensor or detector 120 of any appropriate type. The motion sensor 120 may be positioned on or near the container 180 that is to be monitored. In turn, the motion sensor 120 may provide a signal to the microcontroller 110 that is indicative of movement of the container 180. In one embodiment, the motion sensor 120 may be an accelerometer positioned on or integrated with the container 180. For instance, an accelerometer may be provided with a container body or lid/cover of the container 180. In this regard, motion of the container 180 may be detected by the accelerometer and in turn, the motion detector 120 may provide a signal indicative of motion to the microcontroller 110 (or possibly directly to the alarm 140). The motion sensor 120 may be a micro-electro-mechanical system (MEMS) accelerometer. Alternative or additional devices may be used as a motion sensor 120. For example, the motion sensor 120 may be other types of accelerometers, a mercury tilt switch, or another device capable of detecting motion.

The motion sensor 120 may be located on or otherwise incorporated by the container 180 (e.g., as in the case of an accelerometer, a mercury switch, or the like). In this regard, the motion sensor 120 may be provided on an external container cover, on a container body, or both. Furthermore, the motion sensor 120 may be integrated into a container lid and/or container body. Additionally, the motion sensor 120 may be separately attached to or may entirely separate from (e.g., spaced) the container 180. For instance, the motion sensor 120 may be a passive infrared (PIR) sensor adjacent to the container 180 with a viewing angle that includes an area surrounding the container 180. In this regard, motion of the container 180 or motion near the container 180 can be monitored by the PIR sensor.

The microcontroller 110 may also be in communication with a display 130. The microcontroller 110 may control the display 130 to present a user with information regarding the operation or status of the pharmaceutical product supply 100. For example, the display 130 may be used to display to a user a dosage time period, a dosage interval, the amount of time remaining until the next dosage time period, the amount of time remaining in a current dosage time period, the identity of a pharmaceutical product within the container 180, an alarm status, any other appropriate information, and any combination thereof.

Additionally, the microcontroller 110 may be in communication with the noted alarm 140. The alarm 140 may be operative to provide an alert regarding movement of the container 180. The alarm 140 may be operable to alert a user, such as a person who uses the pharmaceutical product 190 or to whom the pharmaceutical product 190 is prescribed. Stakeholders may also be alerted to movement by way of the alarm 140, which may include a family member of a user, a physician, a nurse, a pharmacist, other caretaker, or other appropriate medical caregiver, for example. The alarm 140 may be an auditory or visual alarm provided in the vicinity of the container 180 that is monitored. In this regard, the alarm 140 may be provided with a container or a container lid. Alternatively or additionally, an alarm 140 may be located remotely from the container 180 (e.g., adjacent to a user tasked with monitoring the container 180). The alarm 140, in the case of an auditory alarm, may be a piezo buzzer, a siren, or other auditory signal relayed to a user. In the case that the alarm 140 is a visual alarm, the alarm 140 may comprise an LED display, an LCD display, a strobe light, or other visual indicator presented to a user indicating an alarm status. In one embodiment, there is both a local alarm 140 (e.g., on or in close proximity to the container 180) and a remote alarm 140 (e.g., spatially located from the container 180, such as in another room in a dwelling, in another dwelling, at a monitoring center, or the like).

Additionally, activating the alarm 140 event may include notifying a user and/or a stakeholder of movement of the container 180 by way of a message delivered electronically to the user and/or stakeholder. In this regard, the pharmaceutical product supply 100 may include a communications device 170. The communications device 170 may employ infrared, radio frequency, Bluetooth, or Wi-Fi wireless technologies, for example. Additionally, the communications device 170 may be operative to communicate via a communications network (e.g., a wide area network such as the Internet, a local area network, a cellular network, an intranet, etc.) in order to send a message indicating that movement of the container 180 was detected. The communications device 170 may be a wireless module capable of communicating via a wireless protocol (e.g., IEEE 802.11a, b, g, n, or other wireless protocol). Accordingly, activating the alarm 140 may include generating and sending an email message, a text message, an instant message, a telephone call, or some other communication via a communications network (or any appropriate communications link) indicating an alarm event. The alarm activation notification sent by the communications device 170 may be received by a human user or may be autonomously monitored or stored. For instance, the number of times the container 180 has been moved may be monitored to assist in prevention of abuse by the patient.

The microcontroller 110 may also include an input device 150. The input device 150 may be responsive to a user such that the user may input information or commands that are in turn received by the microcontroller 110. The input device 150 may be provided with the container 180 such that the input device 150 is integrated into a portion of the container 180 (e.g., container body and/or lid). Alternatively or additionally, the input device 150 may be located remotely from the container 180 and be in communication with the microcontroller 110 such that the microcontroller 110 is operative to receive information from the input device 150.

The input device 150 may include one or more input devices of any appropriate type. That is, a single input device 150 may be provided or multiple input devices 150 may be provided. For instance, the input device 150 may include one or more of buttons (e.g., a ten-key numeric keypad), a touch screen, dials, switches, other input device known in the art, or a combination thereof.

In one embodiment, the input device 150 may comprise a binary input. The binary input may be an on/off switch that controls the activation of the alarm 140. For instance, when the binary input is set to “ON,” the alarm 140 may be active, whereas when the binary input is set to “OFF,” the alarm 140 may be inactive. In this regard, the alarm status may be controlled such that the alarm 140 may be selectively disabled. This may prevent unwanted or “annoyance” alarms. For instance, if traveling, the pharmaceutical product supply 100 may be subject to movement that should not initiate the alarm 140. Accordingly, the alarm 140 may be disabled for this period. This may be by way of the on/off switch or may be accomplished by the programming of quiet times during which the alarm 140 is inactive.

Additionally, the input device 150 may be used by a user to input information regarding the identity of pharmaceutical product 190 stored in the container 180. The input device 150 may also be used by a user to input information regarding a dosing regimen. This may include information regarding dosage times periods, dosage intervals, the medication type, or other such information. Further still, the input device 150 may be operable to program quiet times or to otherwise define one or more time periods and/or conditions where the alarm 140 is to be disabled. For instance, a set duration during which movement should not initiate the alarm 140 may be entered using the input device 150. Alternatively, some time period in the future may be designated as a “quiet time” during which the alarm 140 cannot be initiated. The input device 150 may also be used to receive an input that is operative to cancel or acknowledge activation of an alarm 140 generated by the microcontroller 110.

Once the alarm 140 has been activated, the alarm 140 may continue until an authorized user acknowledges, silences, or otherwise cancels the alarm 140. The input device 150 may allow for a user to indicate the user is authorized (e.g., by way of inputting a PIN or other appropriate code/password associated with an authorized user) to cancel the alarm 140. Further still, the input device 150 may be used to deactivate an alarm 140 prior to the alarm 140 being activated. As such, the input device 150 may allow for deactivation of the alarm 140 to allow for dosing. The alarm 140 may be reactivated after the dosing, or the alarm 140 may automatically reactivate after a certain period of time. The microcontroller 110 may further include a wireless module 160. The wireless module 160 may be operative to facilitate communication between the microcontroller 110 and one or more other devices. For instance, the wireless module 160 may facilitate communication between the microcontroller 110 and various components that may be located remotely from the microcontroller 110. This may include communication between the microcontroller 110 and a motion sensor 120, a display 130, an alarm 140, an input device 150, a communications device 170, or additional components (individually or in any combination). The wireless module 160 may employ infrared, radio frequency, Bluetooth, or other Wi-Fi technology (e.g., IEEE 802.11, etc.).

The wireless module 160, in addition to providing wireless communications between components of the pharmaceutical product supply 100, may also serve as the communications device 170 to provide communication used for the remote alarming capabilities described above (e.g., generation and sending an e-mail message, text message, or the like). In this regard, the wireless module 160 and the network communications module 170 may be provided as a single unit in an embodiment. Additionally, the wireless module 160 may provide communication between the microcontroller 110 (including the various components of the pharmaceutical product supply 100) and a command station or other remote facility such that the operation of the microcontroller 110 may be controlled or monitored remotely.

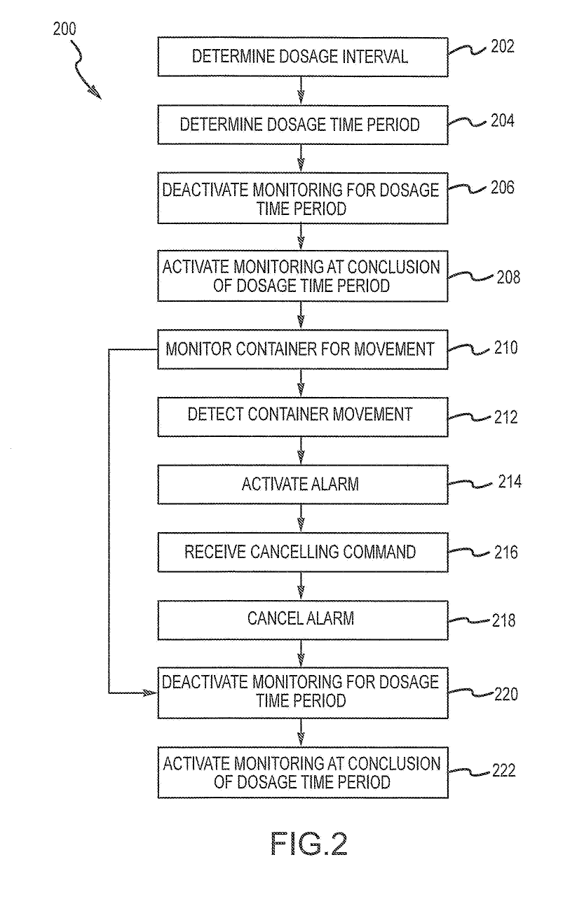

Turning now to FIG. 2, a protocol 200 for monitoring the movement of a pharmaceutical product container (a container with pharmaceutical product stored therein) to assist in the prevention of unauthorized access to the pharmaceutical product is depicted (e.g., in the form of a flow chart). The protocol 200 may be performed by a monitoring device. The protocol 200 may begin by determining (202) a dosage interval for a pharmaceutical product stored in a container. The dosage interval may be input manually by way of an input device. Alternatively, the dosage interval may be communicated to the monitoring device by way of a wireless module. The dosage interval may also be a predefined value stored in a memory of the monitoring device. In one embodiment, the memory of the monitoring device may store a number of dosage intervals that may be selected from depending on the pharmaceutical product stored in the container.

Additionally, the protocol 200 may involve determining (204) a dosage time period for the pharmaceutical product stored in the container. The dosage time period may be manually input by a user (e.g., using an input device or by being received by a wireless module). Alternatively, the dosage time period may be a predefined value stored in a memory of the monitoring device. Further still, the dosage time period may include multiple values stored in memory that may be selected in any appropriate manner.

The protocol 200 may further include deactivating (206) the monitoring of the container during the dosage time period. This deactivation (206) may allow a user to move the container in order to communicate pharmaceutical product to or from the container without activating an alarm. At the conclusion of the dosage time period, the protocol 200 may include activating (208) the monitoring of the container. In this regard, a motion detector may be active to sense movement of the container outside of the dosage time period. Movement detected outside of the dosage time period may initiate an alarm. In this regard, the protocol 200 may include monitoring (210) the container for movement outside of the dosage time period. The protocol 200 may include detecting (212) container movement. The detecting (212) may include a motion sensor sending a signal indicative of container movement to a microcontroller, directly to one or more alarms, or both. In turn, the microcontroller may be operative to activate (214) an alarm. Alternatively, if no container movement is detected (212), the monitoring may be deactivated (220) for a subsequent dosage time period during which a user may move the container to access the pharmaceutical product.

While the protocol 200 is shown using dosage time periods to determine if the alarm should initiate, alternative logic may be employed as well. As discussed above, the protocol 200 may involve determining if the alarm is active (e.g., by scrutinizing an on/off switch) or may involve determining if the detected movement occurred during a quiet time. In any case, the detecting (212) may also involve scrutinizing the detected movement to determine if an alarm should be initiated (214).

Returning to the case where movement is detected (212), an alarm may be activated (214) in response to the detecting (212) of container movement. Additionally, the protocol 200 may include cancelling (218) of the alarm. The cancelling (218) may include silencing an auditory alarm, deactivating a visual alarm, or generating a network communication indicating the alarm has been canceled. In one embodiment, the alarm may be cancelled (218) automatically after a predetermined time. That is, the alarm may sound for a preset amount of time and then time-out and automatically cancel (218). Additionally, the alarm may be cancelled (218) upon receiving (216) a cancelling command. The cancelling command may be received as an input by a user. For instance, a user may enter a PIN or other appropriate code/password using an input device. Upon receipt (216) of the proper PIN, the alarm may be cancelled (218).

Alternatively, a key may be used to cancel (218) the alarm. In one embodiment, the key may comprise a physically keyed object that must be engaged with the pharmaceutical product supply in order to cancel the alarm. Additionally, the key may include a wireless key operative to cooperate with the monitoring device. In this regard, when the wireless key is brought in proximity with the monitoring device, the alarm may be cancelled (218). The wireless key may employ a magnetic element, a radio frequency identification (RFID) element (e.g., a RFID tag), a capacitive element, or some other device operative to be detected when in proximity to the pharmaceutical product supply. In another embodiment, the cancelling (218) of the alarm may be facilitated by receipt of a network communication. The network communication may include a PIN, code, or other appropriate password where upon the receipt of a communication including the proper PIN, etc, the alarm is cancelled (218).

The protocol 200 may further include deactivation (220) of the monitoring (210) for container movement during a second dosage time period. At the conclusion of this second dosage time period, the protocol 200 may include activation (222) of monitoring. This protocol 200 may be repeated such that dosage time periods may be repeated and time periods between the dosage time periods include monitoring of the container for motion, but no monitoring occurs during the dosage time periods.

It is to be understood that while the protocol 200 depicted in FIG. 2 is exemplary for an embodiment of a method, other steps or orders may be used. For instance, in lieu or addition to the dosage time period, other logic may be employed to determine if the alarm should be initiated in response to movement of the container. Additionally, the alarm may be disabled prior to being initiated as opposed to being cancelled once initiated.

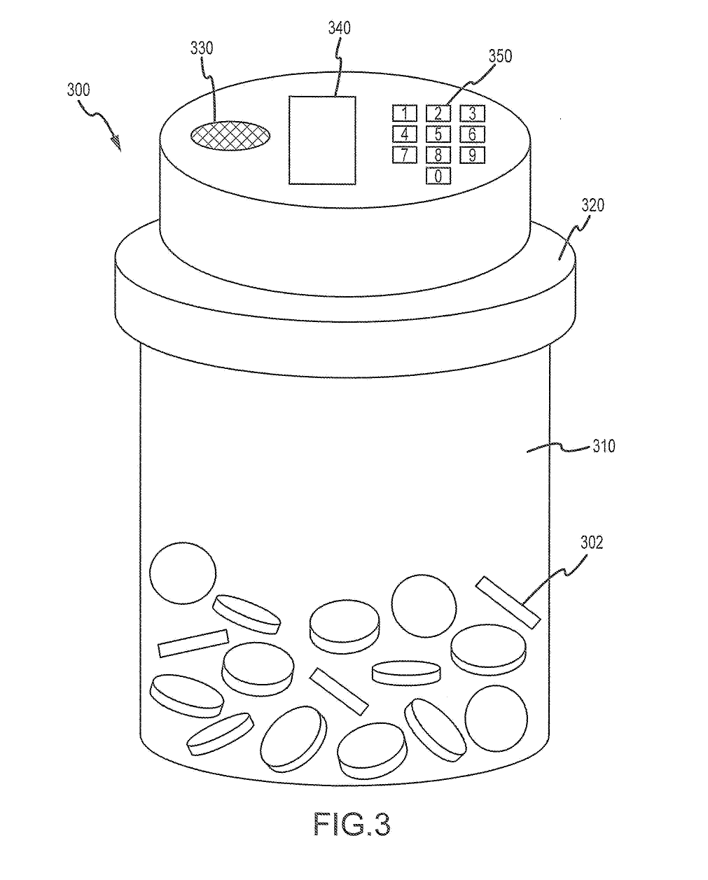

FIG. 3 presents an embodiment of a pharmaceutical product supply 300 that may utilize any one or more of the features discussed above in relation to the pharmaceutical product supply 100 of FIG. 1 and/or the protocol 200 of FIG. 2, unless otherwise noted to the contrary. The discussion presented above with regard to a feature of the embodiment of FIGS. 1 and/or 2 will be equally applicable to the inclusion of any such feature by the pharmaceutical product supply 300.

The pharmaceutical product supply 300 of FIG. 3 may include a container 310 that includes a pharmaceutical product 302 disposed therein. The container 310 may comprise a standard pill bottle. However, other pharmaceutical containers may be used. For instance, the container 310 may comprise a blister package, a vial for storing liquid, a syringe, or any other container used to contain a pharmaceutical product. Additionally, the container 310 may include a container lid 320 (e.g., an external cover). The container lid 320 may incorporate any one or more standard lid features. That is, the container lid 320 may include standard safety features such as a child proof design, standard dimensions, or other standard features of a container lid. The container 310 and container lid 320 may coordinate to contain the pharmaceutical product 302 within the container 310.

In addition to the features recited above, the container lid 320 may include some or all of the components of a monitoring system, such as disclosed above in the embodiment of FIG. 1. In one embodiment, all components of the motion-sensing and alarm functionalities are integrated into the container lid 320, such that the container lid 320 comprising the pharmaceutical product supply 300 may be implemented with any standard pill bottle. For instance, the container lid 320 may include a microcontroller, although such may not be required in all instances. The container lid 320 may include one or more motion sensors as well as an alarm. In one embodiment, the container lid 320 may include an auditory alarm 330. The auditory alarm 330 may comprise a coin cell operated piezo buzzer driven by a packaged integrated circuit or printed circuit board. The piezo buzzer may be capable of producing a loud and/or piercing sound. Alternatively, the piezo buzzer may be programmed or programmable to reproduce a message (e.g., “Put Mommy's pills down, now!”). The alarm 330 may be integrated into the lid 320 such that movement of the container 310 results in activation of the alarm 330. The alarm 330 could be activated directly by the output of one or more motion sensors (e.g., without using a microcontroller).

Additionally, the container lid 320 may include a display 340. The display 340 may be used to communicate information to a user. This information may include dosage time periods, dosage intervals, or other information such as an alarm status. The container lid 320 may also include an input device 350. The input device 350 may be used to input information regarding dosing times, dosing intervals, or other information. Also, the input device 350 may be used to generate a cancelling signal in response to input of a PIN.

The pharmaceutical product supply 300 may be used in order to detect movement of the pharmaceutical product 302 contained therein. For instance, a user may use the input device 350 in order to input information used to determine a dosage time period and a dosage interval for the pharmaceutical product 302. The information may comprise actual values of the dosage interval and the dosage time period, selection of the dosage interval and the dosage time period from memory, or identification of a pharmaceutical product associated with a dosage interval and a dosage time period. This information may be displayed to the user and verified via display 340. The user may then, during the dosage time period, move the container 310 and container lid 320 in order to remove the container lid 320 from the container 310 (or to otherwise gain access to an interior of the container 310). The pharmaceutical product 302 may be removed and the container lid 320 may be replaced on the container 310 in order to thereafter contain the pharmaceutical product 302. Thereafter, the dosing time period may end, and components of the pharmaceutical product supply 300 may be operative to monitor the pharmaceutical product supply 300 for movement. In the event motion of the pharmaceutical product supply 300 is sensed, the pharmaceutical product supply 300 may be operative to activate an alarm 330. This may coincide with a loud piercing noise that may notify those near the pharmaceutical product supply 300 that the container has been moved. As such, motion of the pharmaceutical product supply 300 outside the defined dosing time period may be prevented or at least a third party (e.g., the patient or other stakeholder) may be notified in the event of such motion.

Moreover, if the alarm 330 is activated, the alarm 330 may be cancelled by way of inputting a PIN into the input device 350. As shown in FIG. 3, the input device 350 may comprise a ten-key numeric keypad. However, alternate input devices 350 may be used including an input device with fewer keys, a touch screen, dials, switches, or some other input device. In one embodiment, a binary input (e.g., an on/off switch) may be provided. Additionally, the cancelling of the alarm 330 may also include a wireless interface that is operative to read or sense a wireless key. For instance, an RFID tag may be provided such that bringing the RFID tag in proximity to the container lid 320 may control the alarm 330.

An alternative embodiment of the pharmaceutical product supply 300 may include an alternate method for determining if movement of the container 310 should initiate an alarm. For instance, the container 310 may be equipped with a motion detector that continually monitors whether the container 310 has moved. When movement is sensed, a microcontroller provided with the container 310 may be operative to generate a warning tone (e.g., using a piezo buzzer) indicating to a user that movement has been detected. At this point, a timer may be set during which an authorization key must be received. The authorization key may be received in a similar manner as any of the means used to cancel an alarm discussed above (e.g., by way of an input device 350). Of note, the authorization key may correspond to an authorized user such that only an authorized user may have knowledge or access to the authorization key. Upon receipt of the authorization key, the microcontroller may deactivate the alarm 330, such that additional motion will not trigger an alarm for a certain period of time. This period may be relatively short and correspond roughly to the time needed to remove the container lid 320, remove pharmaceutical product 302, replace the container lid 320, and set the pharmaceutical product supply 300 back in place so that it is stationary. Alternatively, if an authorization key has not been received prior to the expiration of the specified time period following the initial detection of motion, the microcontroller may then activate the alarm 330. In turn, the alarm 330 may be cancelled or silenced by receipt of the authorization key. In this regard, any motion (even motion during a dosage time period) may be scrutinized to determine if the motion should initiate an alarm 330.

The pharmaceutical product supply 300 may also include the ability to program a quiet time—a time period during which movement of the container 310 will not activate the alarm 330. For instance, a user may be able to communicate with the pharmaceutical product supply 300 (e.g., by way of an input device 350 or a wireless module) a time period during which the alarm 330 may be in a deactivated state. Accordingly, the pharmaceutical product supply 300 may be moved without the alarm 330 being activated for this programmed quiet time. In order to program the quiet time, the user may be required to input a personal identification number to indicate that the programming is authorized.

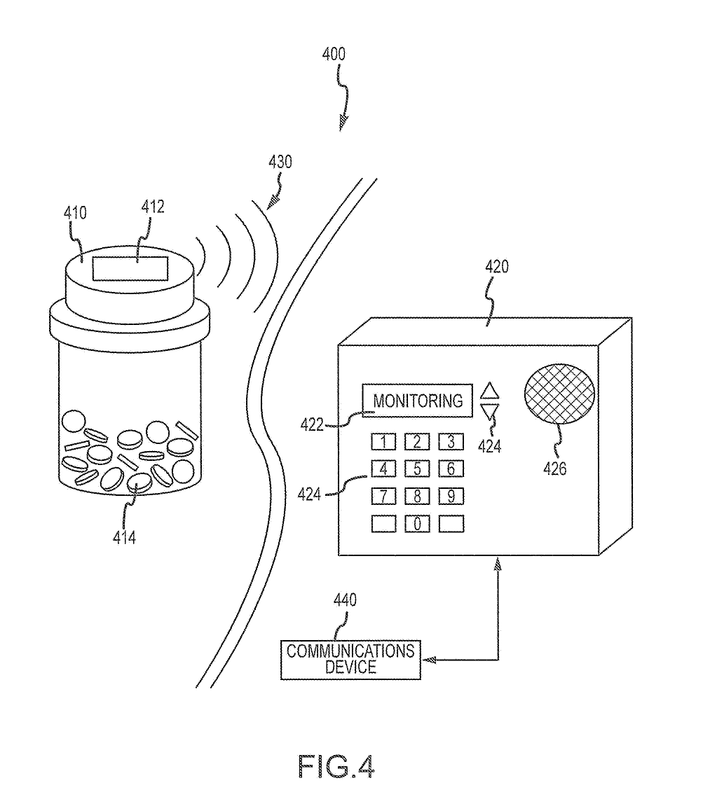

FIG. 4 presents another embodiment of a pharmaceutical product supply 400 that may utilize any one or more of the features discussed above in relation to the pharmaceutical product supply 100 of FIG. 1 and/or the protocol 200 of FIG. 2 unless otherwise noted to the contrary. The discussion presented above with regard to a feature of the embodiment of FIGS. 1 and/or 2 will be equally applicable to the inclusion of any such feature by the pharmaceutical product supply 400, whether incorporated by a container 410 and/or remote command station 420 of the pharmaceutical product supply 400.

The pharmaceutical product supply 400 of FIG. 4 monitors movement of a container 410 for storing a pharmaceutical product 414. The pharmaceutical product supply 400 may include a container 410 and a remote command station 420 located away from the container 410. For instance, the container 410 may be located at a first location (e.g., a bathroom of a user's home) and the remote command station 420 may be provided elsewhere (e.g., in another room of a user's home, a physician's office, or a remote monitoring station). The container 410 and remote command station 420 may be in communication using any appropriate network or communication link (e.g., a wide area network such as the Internet, a local area network, an intranet, or a wireless network). Further, the remote command station 420 and container 410 may be operative to communicate by way of radio frequency, infrared, Bluetooth, or other Wi-Fi technologies (e.g., IEEE 802.11, or some other wireless protocol).

The container 410 may include an integrated motion sensor 412. The motion sensor 412 may comprise a MEMS accelerometer or other accelerometer capable of monitoring movement of the container 410, as well as any of the other motion sensors or detectors identified herein. Upon sensing of motion by the motion sensor 412, the container 410 may utilize a wireless communication to send a motion signal 430 to the remote command station 420 indicative of motion of the container 410. It should be appreciated that the motion signal 430 may be sent to the remote command station 420 over any appropriate communication link. The motion sensor 412 could also communicate with an alarm (not shown) incorporated by the container 410 at this time and in the manner discussed above regarding the embodiment of FIG. 3.

The remote command station 420 may include a display 422, an input device 424, and an alarm 426. The display 422 may be used in conjunction with the input devices 424 in order for a user to input information and for information to be displayed to a user. For instance, the user may be able to specify dosage time periods, dosage intervals, the identity of the container 410, the identity of the pharmaceutical product 414, or other information, which can then displayed to the user.

Upon receipt of a motion signal 430 at the remote command station 420, the remote command station 420 may include logic to determine whether the motion should activate the alarm 426. For instance, if the motion of the container 410 occurred during a dosage time period associated with the pharmaceutical product 414 stored in the container 410, the remote command station 420 may be operative to disregard the motion signal 430. However, in the event the motion signal 430 is received at the command station 420 outside of the defined dosage time period, the remote command station 420 may be operative to initiate or activate the alarm 426 (an alarm incorporated by the container 410 could also be activated from an output from the motion sensor 412, or could be activated via a signal sent back from the remote command station 420 to the container 410). Further still, the command station 420, upon receipt of a motion signal 430 may determine if the alarm 426 is active. For instance, an on/off switch at the remote command station 420 may be set to “OFF,” such that the alarm 426 would not be initiated at this time. Further still, a quiet time may have been programmed such that a received motion signal 430 during the quiet time may not result in initiation of the alarm 426.

One example of an alarm event would be to activate or sound an auditory alarm 426. The auditory alarm 426 may comprise a siren, piezo buzzer, or other sound-producing alarm capable of notifying a third person that the container 410 has been moved. As the remote command station 420 may be located remotely from the container 410, a user away from the vicinity of the container 410 may be notified of movement of the container 410. Additionally, the remote command station 420 may be in communication with a network or other communications device 440 capable of sending a network communication (or via any other appropriate communication link) to one or more other remotely-located devices. Examples of this include the remote command station 420 being operative to produce and send an e-mail message, a text message, an instant message, a telephone call, or other communications in order to notify a user of motion of the container 410.

The input device 424 may be further used in order to cancel an activated alarm 426 (e.g., an alarm event) generated by the remote command station 420. Additionally, the alarm cancelling function may be by way of a network communication (e.g., an e-mail, a text message received by the remote command station 420 with a code or PIN authorizing the user to cancel an activated alarm 426). The remote command station 420 may be operative to monitor multiple containers 410 and track multiple dosage times and dosage intervals associated with more than one corresponding containers 410.

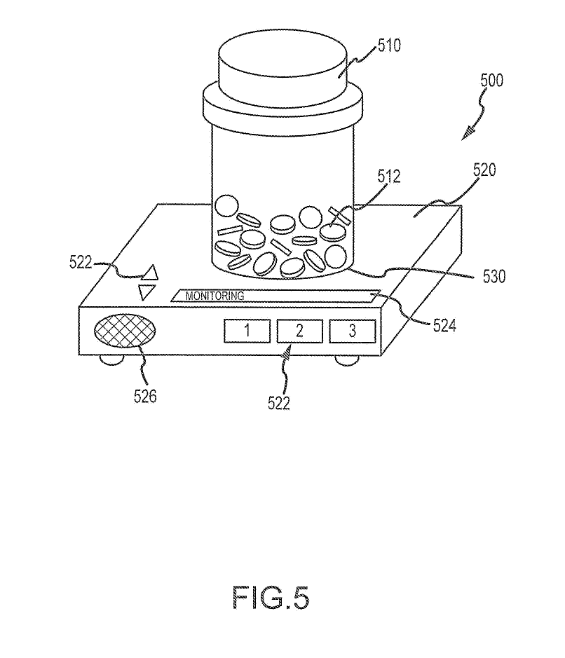

FIG. 5 presents another embodiment of a pharmaceutical product supply 500 that may utilize any one or more of the features discussed above in relation to the pharmaceutical product supply 100 of FIG. 1 and/or the protocol 200 of FIG. 2 unless otherwise noted to the contrary. The discussion presented above with regard to a feature of the embodiment of FIGS. 1 and/or 2 will be equally applicable to the inclusion of any such feature by the pharmaceutical product supply 500, whether incorporated by a container 510 and/or a base unit 520 of the pharmaceutical product supply 500.

The pharmaceutical product supply 500 of FIG. 5 monitors movement of a container 510 for containing a pharmaceutical product 512. In the pharmaceutical product supply 500, the container 510 may be placed into a receptacle 530 defined in a base or base unit 520, although the container 510 may be “docked” to the base 520 in any appropriate manner. In any case, the base 520 may include a device operative to monitor the container 510 such that removal of the container 510 from the base 520 may result in an alarm event (e.g., activate an alarm 526 on the base 520, although an alarm could also be incorporated by the container 510—not shown in FIG. 5). Accordingly, the base 520 may include one or more sensors or detectors, disposed in any appropriate arrangement, to determine if the container 510 has been removed from the base 520. Any such a sensor may be of any appropriate type, for instance a mechanical or optical sensor. Alternatively, the container 510 and base 520 may employ inductive coupling as a means to determine proximity or movement.

Accordingly, an authorized user may know to maintain the container 510 in the receptacle 530 when removing pharmaceutical product 512 from the container 510. That is, the alarm 526 may be initiated upon (e.g., immediately) the container 510 being removed from the base 520. Other configurations are possible. For instance, the alarm 526 could also be activated if the container 510 is not replaced back on the base 520 within a certain amount of time after being removed from the base 520 to access pharmaceutical product 512. That is, the pharmaceutical product supply 500 may be configured to allow the container 510 to be removed from the base 520 to allow an individual to open the container 510 while disassociated from the base 520, but the container 510 would need to be returned to the base 520 within a certain period of time or else the alarm 526 will be activated. In another configuration, the alarm 526 may be activated when the container 510 is removed from the base 520 outside of a defined dosage time period associated with a dosage interval of the pharmaceutical 512. In yet another configuration, the pharmaceutical product supply 500 may track the time period since the container 510 was last removed from the base 520 such that premature removal of the container 510 (that is, removal prior to the next appropriate dosage interval) may initiate the alarm 526. Any combination of two or more of these alarm configurations could be utilized by the pharmaceutical product supply 500.

The pharmaceutical product supply 500 may include an alarm 526 (e.g., comprising an auditory alarm capable of producing a piercing noise or a siren) on the base 520 to indicate movement of the container 510. As noted, an alarm could also be incorporated by the container 510. In any case, the base 520 may include an input device 522 that may be used to input information or otherwise cancel an alarm event once the alarm 526 has been triggered. Moreover, the base 520 may include a display 524 for relaying information to a user. In this regard, the pharmaceutical product supply 500 of FIG. 5 may be used with a standard pill bottle or other medical container 510.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A pharmaceutical product supply, comprising:
a container;
a motion sensor associated with said container;
pharmaceutical product within said container;
an alarm operatively interconnected with said motion sensor; and
control logic operatively interconnected with each of said motion sensor and said alarm, wherein said control logic comprises a dosage time period, wherein movement of said container during said dosage time period and detected by said motion sensor fails to initiate said alarm, and wherein movement of said container outside said dosage time period and detected by said motion sensor initiates said alarm.

2. The pharmaceutical product supply of claim 1, further comprising:
a base unit, wherein said container is connectable to said base unit, and wherein movement of said container from said base unit is detected by said motion sensor.

3. The pharmaceutical product supply of claim 2, wherein said control logic is configured to allow said container to be removed from said base unit for a first time period, and wherein failure to reconnect said container to said base unit within said first time period initiates said alarm.

4. The pharmaceutical product supply of claim 1, wherein said alarm is selected from the group consisting of an auditory alarm, a visual alarm, a wireless communication, an e-mail, a voicemail, a text message, an MMS message, an instant message, a telephone call, or any combination thereof.

5. The pharmaceutical product supply of claim 1, wherein said alarm comprises a programmable alarm.

6. The pharmaceutical product supply of claim 5, wherein said programmable alarm comprises a customized message.

7. The pharmaceutical product supply of claim 1, further comprising:
an on/off switch operatively interconnected with said alarm.

8. The pharmaceutical product supply of claim 1, further comprising:
an alarm control module operable to control said alarm, wherein said alarm control module is operable to disable said alarm prior to said alarm being initiated when movement of said container outside said dosage time period is detected by said motion sensor.

9. The pharmaceutical product supply of claim 1, further comprising:
an alarm control module operable to control said alarm, wherein said alarm control module is operable to cancel said alarm after said alarm has been initiated.

10. The pharmaceutical product supply of claim 1, further comprising:
an alarm control module operable to control said alarm, wherein said alarm control module comprises an input, and wherein said input comprises a binary input comprising an on/off command.

11. The pharmaceutical product supply of claim 1, further comprising;
an alarm control module operable to control said alarm, wherein said alarm control module comprises an input, and wherein said input is operable to receive a control command comprising a personal identification code.

12. The pharmaceutical product supply of claim 1, further comprising:
an alarm control module operable to control said alarm, wherein said alarm control module comprises a wireless module; and
a wireless key, wherein when said wireless key is proximate to said wireless module, said alarm is disabled.

13. The pharmaceutical product supply of claim 1, further comprising:
an alarm control module operable to control said alarm, wherein said alarm control module comprises a timer, and wherein upon expiration of said timer, said alarm is cancelled.

14. The pharmaceutical product supply of claim 1, wherein said control logic comprises a programmable quiet time during which said alarm is inactive regardless of if movement of said container is detected by said motion sensor.

15. The pharmaceutical product supply of claim 1, further comprising:
a remote alarm operatively interconnected with said motion sensor and said control logic,

16. A method for monitoring a pharmaceutical product, comprising the steps of:
tracking a dosage time period;
monitoring a position of a pharmaceutical product container, wherein said pharmaceutical product container comprises a pharmaceutical product;
detecting movement of said pharmaceutical product container from said monitoring step; and
activating an alarm in response to said detecting step when said detecting step occurs outside of said dosage time period.

17. The method of claim 16, wherein said detecting step comprises detecting removal of said pharmaceutical product container from a base unit.

18. The method of claim 17, wherein said activating step is executable upon removal of said pharmaceutical product container from said base unit.

19. The method of claim 17, wherein said activating step is executable upon occurrence of a first condition, said first condition being that said pharmaceutical product container remains removed from said base unit for more than a predetermined amount of time.

20. The method of claim 16, wherein said activating step comprises activating an alarm selected from the group consisting of an auditory alarm, a visual alarm, a wireless communication, an e-mail, a voicemail, a text message, an MMS message, and instant message, a telephone call, or any combination thereof.

21. The method of claim 16, wherein said activating step comprises activating a remote alarm.

22. The method of claim 16, further comprising the step of:
programming said alarm.

23. The method of claim 22, wherein said programming step comprises recording a customized message.

24. The method of claim 16, further comprising the step of:
controlling said alarm, wherein in a first instance an alarm control command is received and in a second instance an alarm control command is not received, wherein said detecting step in said second instance results in execution of said activating step, and wherein said detecting step in said first instance does not result in execution of said activating step.

25. The method of claim 16, further comprising the step of:
controlling said alarm, wherein said controlling step comprises disabling said alarm prior to execution of said activating step.

26. The method of claim 16, further comprising the step of
controlling said alarm, wherein said controlling step comprises cancelling said alarm during execution of said activating step.

27. The method of claim 16, further comprising the step of:
controlling said alarm, wherein said controlling step comprises receiving an input, and wherein said input comprises an on/off command.

28. The method of claim 16, further comprising the step of:
controlling said alarm, wherein said controlling step comprises receiving an input, and wherein said input comprises a personalized code.

29. The method of claim 16, further comprising the step of:
controlling said alarm, wherein said controlling step comprises receiving a control command via a wireless module, wherein said controlling step further comprises introducing a wireless key in proximity to said wireless module, and wherein said wireless key controls said alarm.

30. The method of claim 16, further comprising the step of:
controlling said alarm, wherein said controlling step comprises controlling said alarm based on a timer.
